(19) United States
(12) Patent Application Publication
(10) Pub. No.: US 2004/0211614 A1
(43) Pub. Date: Oct. 28, 2004

(54) Hydraulically driven vehicle

(76) Inventor: Nobuo Matsuyama, Komatsu-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/691,960

(22) Filed: Oct. 24, 2003

(30) Foreign Application Priority Data
Oct. 28, 2002 (JP) 2002-312215

(51) Int. Cl. B60K 17/00; F16D 39/00

(52) U.S. Cl. 180/305; 60/329

(57) ABSTRACT

The invention provides a hydraulically driven vehicle which can reduce a tire slip on a low friction road surface such as a soft road surface, an oversnow road surface or the like and has an excellent work ability in a narrow space. The invention relates to a hydraulically driven vehicle having a hydraulic motor (2) driven by a pressure oil discharged from a hydraulic pump (1) and supplied to the hydraulic motor (2), and traveling by driving the hydraulic motor (2). A maximum driving force of the hydraulic motor (2) is set changeable. The hydraulic motor (2) is a variable displacement hydraulic motor. A maximum driving force is adjusted by electrically controlling a maximum tilt angle of the hydraulic motor (2). A minimum displacement value of the hydraulic motor (2) can be changed by electrically controlling a minimum tilt angle of the hydraulic motor (2).

### BACKGROUND OF THE INVENTION

1. Field of the Invention

The present invention relates to a hydraulically driven vehicle such as a wheel loader and the like.

2. Description of the Backgraound Art

In conventional, as a hydraulic circuit of this kind of hydraulically driven vehicle, there is a hydraulic circuit as shown in FIG. 8 structured such that a hydraulic pump for a working machine is driven by a part of an output from an engine, a working machine cylinder is operated via the hydraulic circuit for the working machine, the hydraulic pump is driven by the rest portion of the output from the engine, and a variable displacement hydraulic motor is rotated via a main circuit by a pressure oil generated in the hydraulic pump.

In the hydraulic circuit, a part of an output from an engine 51 drives a hydraulic pump 52 for a working machine and is applied to a working machine cylinder 54 via hydraulic circuit 53 for a working machine, the rest portion of the output from the engine 51 drives a control pump 55 and a hydraulic pump 56, and a pressure oil generated in the hydraulic pump 56 rotates a variable displacement, hydraulic motor 59 through main circuits 57 and 58 so as to apply a driving force to the vehicle.

Reference numeral 60 denotes a pump control valve for controlling a displacement of the hydraulic pump 56, reference numeral 61 denotes a pump displacement control cylinder, reference numerals 62 and 62 denote a main relief valve, reference numeral 63 denotes a charge relief valve, and reference numeral 64 denotes a filter. Further, a hydraulic pressure passing through a motor control oil passage 65 from the pump control valve 60 is introduced to one end of a motor control valve 66 so as to introduce a pressure oil in a high-pressure side introduced from the main circuits 57, and 58 by a pilot pipe 67′ to a motor displacement control cylinder 68.

In other words, the structure its made such that a speed of the vehicle can be regulated by controlling the pump displacement control cylinder 61 and the motor displacement control cylinder 68 by the pump control valve, 60 and the motor control valve, 66 so as to optionally change the displacements of the hydraulic pump 56 and the hydraulic motor 59.

Accordingly, in the vehicle provided with the hydraulic circuit as shown in FIG. 8, a travel driving force and a traveling speed are continuously changed and it is possible to automatically-change speed from a maximum driving force (a vehicle speed 0) to a maximum speed with no gear change operation. Therefore, a driver can control a vehicle speed and a drive force only by an accelerator pedal, and there can be obtained an advantage that a traveling operation can be easily achieved.

In the case of traveling while ascending the working machine in a narrow space, a work effectiveness (a workability) is made better by ascending the working machine at the maximum ascending speed and restricting the traveling speed to a low level. However, in the structure shown in FIG. 8, when ascending the working machine at the maximum ascending speed, the vehicle speed is simultaneously increased up to the maximum vehicle speed. Accordingly, there has been a structure in which only the maximum vehicle speed can be optionally regulated while keeping the traveling performance, corresponding to a feature of the continuous speed change hydraulically driving vehicle (for example, refer to patent document 1) . The patent document 1 describes a structure in which the structure shown in FIG. 8 is additionally provided with a vehicle speed cut-off apparatus 70 for controlling a minimum displacement of the motor 59, as shown in FIG. 9. The vehicle speed cut-off apparatus 70, is provided with a pressure control valve 76. The pressure control valve 76 reduces a pressure in a pilot pipe 74 by balancing a differential pressure between a pressure in a pilot pipe 71 and a pressure in a pilot pipe 72 with a spring 73, thereby reducing a pressure in a pilot pipe 74 and generating a pressure applied to the motor control valve 66 (a pressure in the pilot pipe 75). Further, the minimum displacement value of the hydraulic motor 59 is made variable by adjusting a spring force of the spring 73.

Patent Document 1

A Japanese Utility Model Publication No. 7-40764 (pages 2-3, FIG. 1)

However, in the structure shown in FIG. 8 and the structure shown in FIG. 9 (the structure described in patent document 1), a maximum tilt angle of the hydraulic motor 59 is determined in accordance with a stroke end caused by a pressing of the spring, so that a maximum driving force of the hydraulic motor 59 can not be optionally changed. Accordingly, in the case that an accelerator pedal is stepped on in order to secure a working amount by the working machine on a low friction road surface such as a soft road surface, an oversnow road surface or the like, the driving force of a tire can not be restricted and there is a risk that a tire slip is generated. Further, since the maximum driving force is fixed, it is hard to adjust the force in correspondence to the subject to be excavated during the work by the working machine, and a working reliability is deteriorated.

Further, in the structure in FIG. 9 mentioned above, it is securely possible to continuously control the maximum vehicle speed by optionally controlling the minimum displacement of the motor, however, since the vehicle speed cut-off apparatus 70 is of a hydraulic control type, the circuit is complicated and requires an increased cost, and only a complicated control can be executed.

### SUMMARY OF THE INVENTION

The present invention is made for the purpose of solving the problems in the prior arts mentioned above, and an object of the present invention is to provide a hydraulically driven vehicle which can reduce a tire slip on a low friction road surface such as a soft road surface, an oversnow road surface or the like and has an excellent workability in a narrow space or the like on the basis of a simple structure.

In accordance with claim 1 of the present invention, there is provided a hydraulically driven vehicle comprising a hydraulic motor 2 driven by a pressure oil discharged from a hydraulic pump 1 and supplied to the hydraulic motor 2, the hydraulically driven vehicle being traveled by driving the hydraulic motor 2, wherein a maximum driving force of the hydraulic motor 2 is set changeable.

In accordance with the hydraulically driven vehicle on the basis of claim 1 mentioned above, since the maximum driving force of the hydraulic motor 2 is set changeable, it is possible to prevent a vehicle tire from slipping by adjusting the maximum driving force on the low friction road surface such as the soft road surface, the oversnow road surface or the like. Accordingly, a stable work can be carried out Further, in the case of having a working machine 27, when carrying out the work by the working machine 27, it is possible to change a resultant force of a driving force (a pressing force of a bucket of the working machine in a horizontal direction) and a working machine force (an ascending force of the bucket of the working machine in a vertical direction) by adjusting the driving force. Accordingly, it is possible to apply the resultant force in correspondence to a subject to be excavated, and it is possible to carry out a reliable work.

In accordance with claim 2 of the present invention, there is provided a hydraulically driven vehicle, characterized in that the hydraulic motor 2 is a variable displacement hydraulic motor, and a maximum tilt angle of the hydraulic motor 2 is set changeable.

In accordance with the hydraulically driven vehicle on the basis of claim 2 mentioned above, it is possible to chan the maximum driving force of the hydraulic motor 2 by changing the maximum tilt angle of the hydraulic motor 2, whereby it is possible to improve a reliability with regard to changing the maximum driving force. Accordingly, it is possible to stably prevent the tire slip on the low friction road surface such as the soft road surface, the oversnow road surface or the like.

In accordance with claim 3 of the present invention, there is provided a hydraulically driven vehicle, characterized in that the maximum tilt angle is adjusted in accordance with an electronic control.

In accordance with the hydraulically driven vehicle on the basis of claim 3 mentioned above, since the maximum tilt angle is adjusted in accordance with the electronic control, it is possible to securely, continuously and delicately adjust the maximum tilt angle. Further, since this adjustment is not based on the hydraulic control method, a simple circuit structure can be achieved, and it is possible to achieve a reduction in cost.

In accordance with claim 4 of the present invention, there is provided a hydraulically driven vehicle, characterized in that a minimum tilt angle of the hydraulic motor 2 is adjusted in accordance with an electronic control.

In accordance with the hydraulically driven vehicle on the basis of claim 4 mentioned above, since the minimum tilt angle of the hydraulic motor 2 is adjusted, it is possible to, change a minimum displacement value of the hydraulic motor 2, and it is possible to control a maximum vehicle speed. Accordingly, it is possible to obtain the vehicle speed in correspondence to the working condition, and in the case of having the working machine 27 when ascending the working machine 27 at a high speed, it is possible to make the vehicle speed low, and it is possible to correspond to the work in the narrow space. Further, since the minimum tilt angle is adjusted in accordance with the electronic control, it is possible to securely, continuously and delicately adjust the minimum tilt angle. Further, since this adjustment is not based on the hydraulic control method, a simple circuit structure can be achieved, and it is possible to achieve a reduction in cost.

In accordance with claim 5 of the present invention, there is provided a hydraulically driven vehicle, characterized in that the hydraulically driven vehicle is provided with a selecting means for selecting whether or not the change of the hydraulic motor 2 is executed.

In accordance with the hydraulically driven vehicle on the basis of claim 5 mentioned above, since there is provided the selecting means for selecting whether or not the change of the hydraulic motor 2 (the change in the maximum tilt angle and the minimum tilt angle) is executed, an operator can optionally change the maximum tilt angle and change the minimum tilt angle, and it is possible to carry out an operation in which the vehicle speed ascends up to the maximum vehicle speed at the same time of ascending the working machine at the maximum ascending speed. Accordingly, it is possible to carryout an operation (work) in correspondence to a preference of the operator, a working condition or the like, and it is possible to achieve an improvement of a working efficiency.

### BRIEF DESCRIPTION OF THE DRAWINGS

FIG. 1 is a simplified circuit view showing an embodiment of a hydraulically driven vehicle in accordance with the present invention;

FIG. 2 is a simplified view showing a control portion of the hydraulically driven vehicle;

FIGS. 3A and 3B show a switching means used for adjusting a maximum tilt angle of the hydraulically driven vehicle, in which FIG. 3A is a simplified view of a continuous changeover switch and FIG. 3B is a simplified view of a stepped changeover switch;

FIG. 4 is a graph showing a relation between a tilt angle of the hydraulically driven vehicle, a main circuit hydraulic pressure and an engine speed;

FIG. 5 is a graph showing condition of adjustment of a maximum tilt angle of the hydraulically driven vehicle;

FIG. 6 is a graph showing a relation between a vehicle speed of the hydraulically driven vehicle and a driving force;

FIG. 7 is a schematic view showing the driving force of the hydraulically driven vehicle and a working machine force;

FIG. 8 is a simplified circuit view of a conventional hydraulically driven vehicle; and

FIG. 9 is a simplified circuit view of an other conventional hydraulically driven vehicle.

### DESCRIPTION OF THE PREFERRED EMBODIMENT

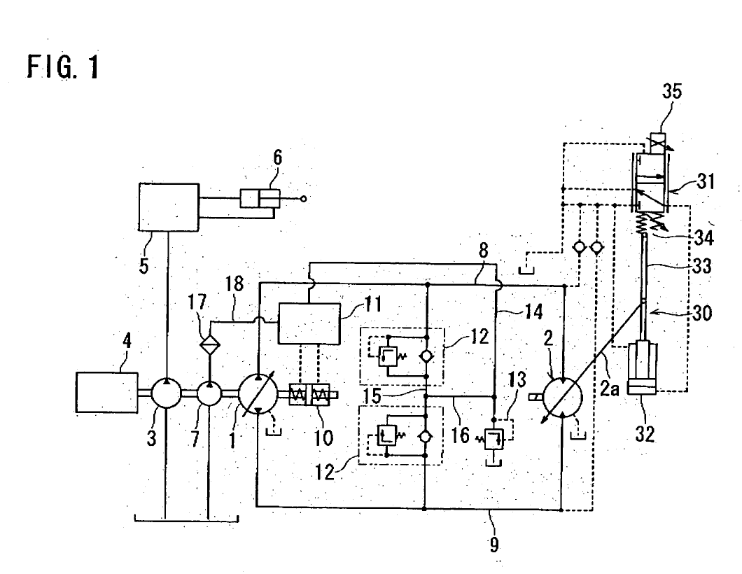

Next, a description will be given in detail of a particular embodiment of a hydraulically driven vehicle in accordance with the present invention with reference to the accompanying drawings. FIG. 1 shows a simplified view of a hydraulic circuit of a hydraulically driven vehicle, and the hydraulically driven vehicle employs, for example, a construction machine such as a wheel loader or the like.

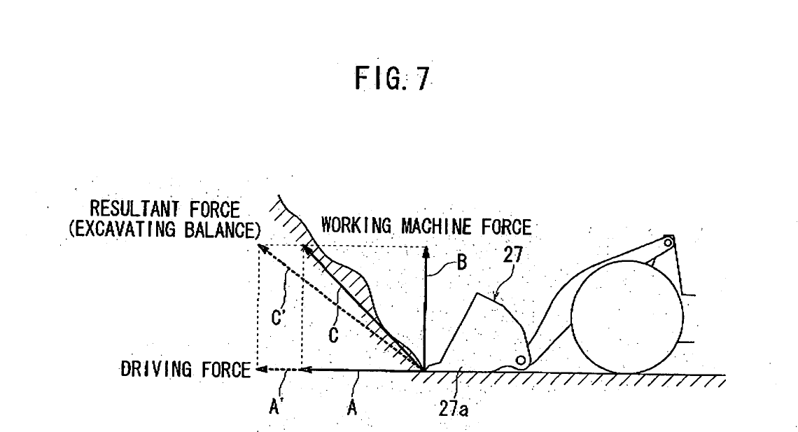

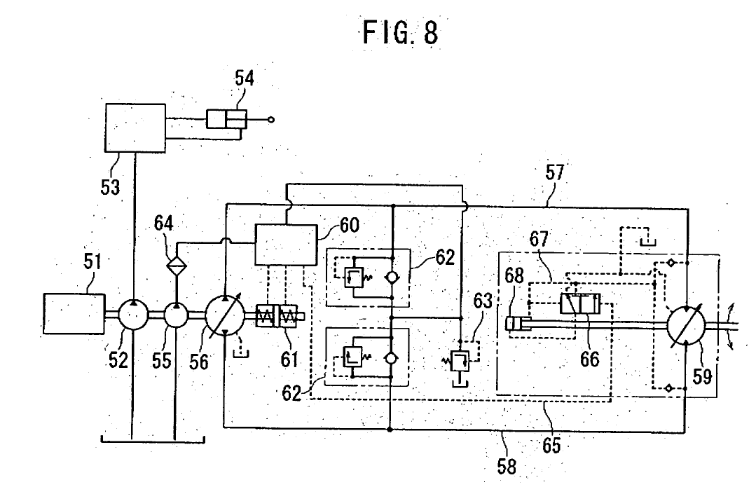

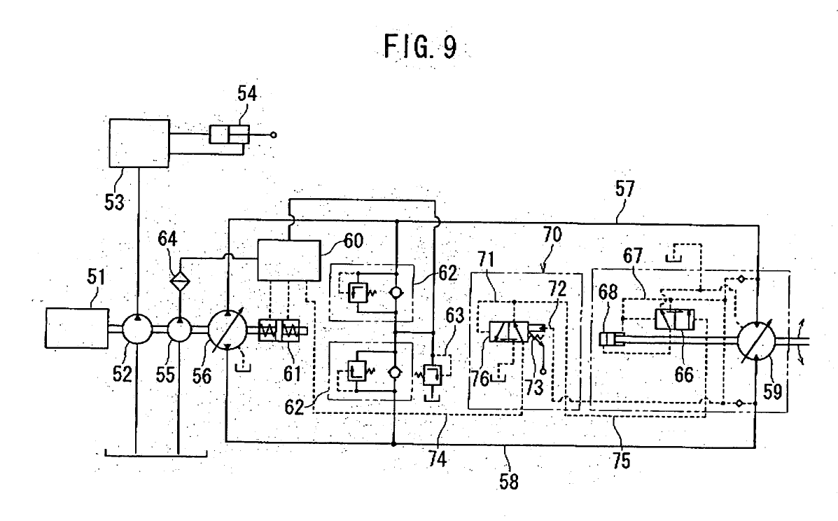

A hydraulic circuit of the hydraulically driven vehicle is provided with a variable displacement hydraulic pump 1, a variable displacement hydraulic motor 2; a hydraulic pump 3 for a working machine and the like. Further, the working machine hydraulic pump 3 is driven by driving an engine 4, whereby a hydraulic cylinder 6 for a working machine is driven via a hydraulic circuit 5 for a working machine, and a bucket 27a refer to FIG. 7) of a working machine 27 is operated. Further, a control pump 7 and the variable displacement hydraulic pump 1 are driven by driving the engine 4. A pressure oil generated by driving the variable displacement hydraulic pump 1 flows to the variable displacement hydraulic motor 2 through main circuits 8 and 9, and the variable displacement hydraulic motor 2 is driven.

Further, to the variable displacement hydraulic pump 1, there are connected a pump displacement control cylinder 10 for controlling a displacement of the pump land a pump control valve 11. Further, relief valves 12 and 12 are connected to the main circuits 8 and 9, and a charge relief valve 13 is connected to the pump control valve 11. Further, a pipe 14 for connecting the pump control valve 11 to the charge relief valve 13 is connected to a pipe 15 for connecting the relief valves 12 and 12 via a pipe 16. In this case, the control pump 7 and the pump control valve 11 are connected by a pipe 18 in which a filter 17 is interposed. Accordingly, it is possible to control the pump displacement control cylinder 10 by the pump control valve 11, and it is possible to change a displacement of the hydraulic pump 1,

In this case, the variable displacement hydraulic motor 2 mentioned above is a bent axis type motor in which a tilt angle (an angle of inclination) can be changed in accordance with an electronic control, for example, a solenoid type motor. A control means in this case is provided with a cylinder 30 and a control valve 31. Further, the cylinder 30 has a cylinder main body 32 and a piston rod 33 expanding and contracting with respect to the cylinder main body 32, and is structured such that an angle of the bent axis, that is, the tilt angle can be changed by the piston rod 33. Further, the piston rod 33 is connected to the control valve 31. Accordingly, the displacement of the hydraulic motor 2 can be optionally changed by controlling the cylinder 30 by means of the control valve 31.

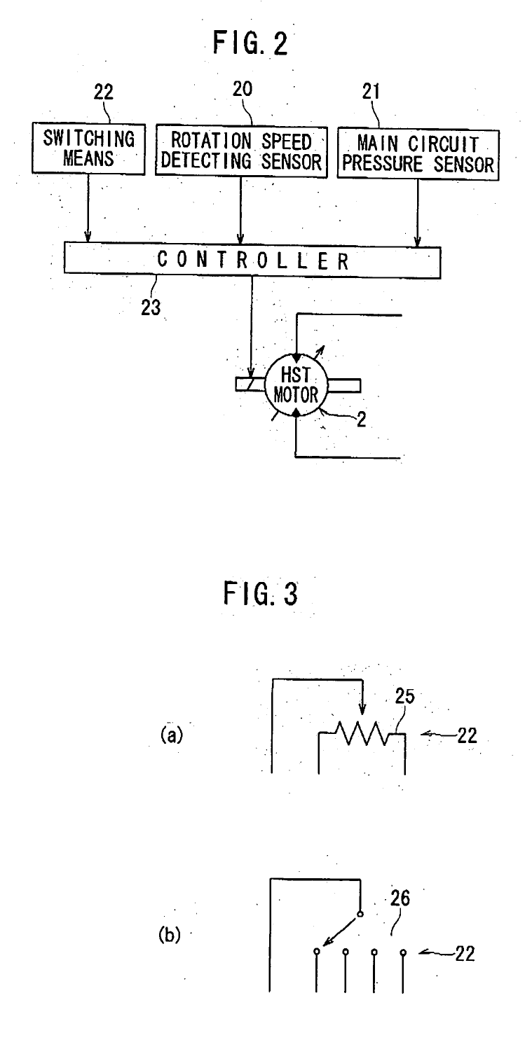

Further, it is possible to adjust a maximum tilt angle and a minimum tilt angle by adjusting an electric current value itself applied to a solenoid 35. Accordingly, a control portion of the hydraulic circuit is provided, as shown in FIG. 2, with a rotation speed detecting sensor 20 for detecting a rotation speed of the engine 4, a main circuit pressure sensor 21 for detecting the main circuits 8 and 9, a switching means 22, a controller (a control means) 23 to which signals from the sensors 20 and 21 and the switching means 22 are input, and the like. The controller 23 processes the input data and outputs a command of changing the tilt angle to the variable displacement hydraulic motor 2.

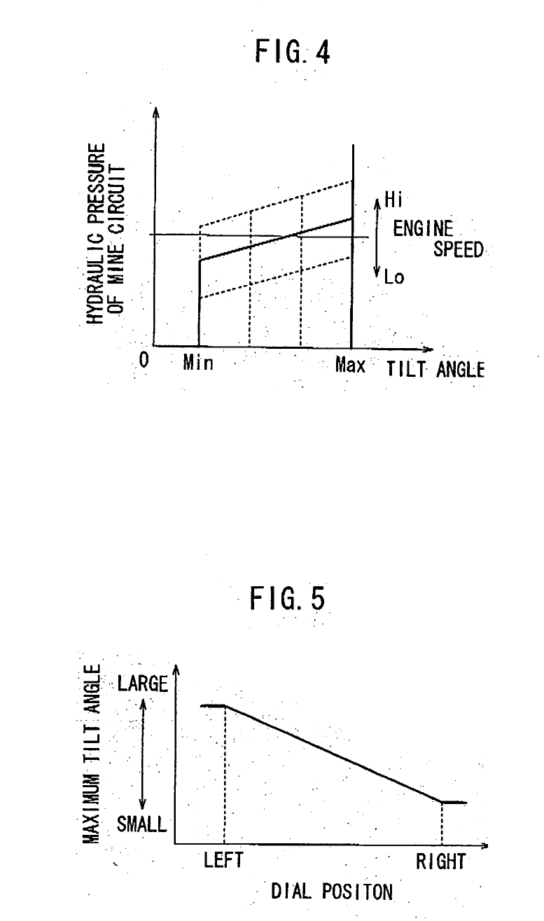

FIG. 4 shows a relation between the tilt angle, hydraulic pressures of the main circuits 8 and 9 and the engine speed. A solid line in FIG. 4 corresponds to a line defining the tilt angle with respect to the hydraulic pressures of the main circuits 8 and 9, in a state in which the engine speed is a certain value. The tilt angle is minimum (Min) in the case that the hydraulic pressures of the main circuits 8 and 9 are equal to or less than a certain fixed value, the tilt angle becomes gradually large in correspondence to an ascent of the hydraulic pressure (a solid inclined portion), and after the tilt angle, becomes a maximum (Max), the tilt angle maintains the maximum tilt angle even when the hydraulic pressure is increased.

The inclined portion of the solid line is set sodas to ascend and descend in accordance with the engine speed. In other words, when the engine-speed is low the tilt angle becomes large from a state in which the hydraulic pressures of the main circuits 8 and 9 are lower, and the control is executed such that the maximum tilt angle is achieved in a state in which the hydraulic pressures of the main circuits 8 and 9 are lower (refer to an inclined portion of a lower broken line in FIG. 4). On the contrary, when the engine speed is high, the minimum tilt angle is maintained until the hydraulic pressures of the main circuits 8 and 9 become higher, and the control is executed such that the maximum tilt angle is achieved in a state in which the hydraulic pressures of the main circuits 8 and 9 are higher (refer to an inclined portion of an upper broken line in FIG. 4). Further, the minimum value and the maximum value of the tilt angle can be changed by the switching means 22 (refer to vertical broken lines in FIG. 4). The switching means 22 can be constituted by a continuous switching switch 25 shown in FIG. 3A, a stepped changeover switch 26 shown in FIG. 3S or the like. In the continuous changeover switch 25 shown in FIG. 3A, it is possible to change the minimum value and the maximum value of the tilt angle by adjusting a dial position. In the stepped changeover switch 26 shown in FIG. 3B, it is possible to switch into four stages, however, the number of stages is not, of course, limited to this, and the switch may be changed into three stages or less, or may be changed into five stages or more.

Accordingly, when using the continuous changeover switch 25, it is possible to switch the position of Min and the position of Max in FIG. 4 in a stepless manner (continuously). When using the stepped changeover switch 26, it is possible to switch into some stages. Further, FIG. 5 shows a relation between the dial position and the maximum tilt angle in the case of using the continuous changeover switch 25. This shows that the maximum tilt angle can be continuously changed by adjusting the dial. In this case, the more the dial is turned to a right side, the smaller the maximum tilt angle is, however, this may be set reverse. In this case, FIG. 5 shows the changeover switches 25 and 26 used for adjusting the maximum tilt angle. However, the changeover switch may be, of course, used for adjusting the minimum tilt angle. In this case, the switch for adjusting the maximum tilt angle and the switch for adjusting the minimum tilt angle may be different or the same. In the case of the same switch, it is necessary to switch between a side of the maximum tilt angle and a side of the minimum tilt-angle.

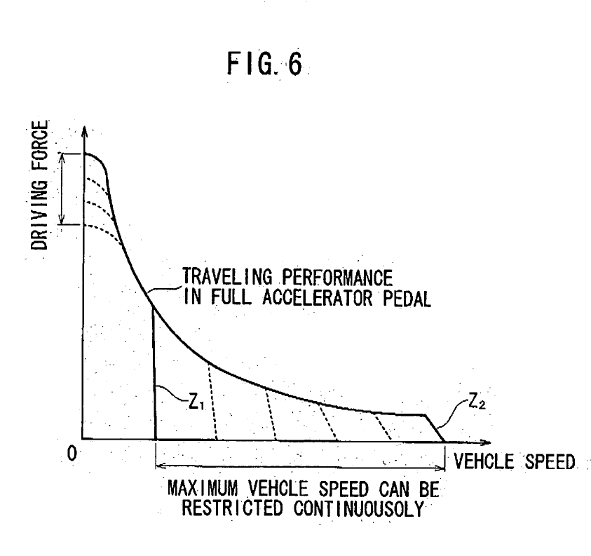

As mentioned above, it is possible to change the maximum tilt angle, and it is possible to adjust the motor driving force (the maximum traction force in a so-called pedal-full state in which the accelerator pedal is stepped on at a maximum) by changing (adjusting) the maximum tilt angle, as shown by a broken line in FIG. 6. Accordingly, even when the accelerator pedal is stepped on at a maximum for the purpose of securing the working amount by the working machine 27, on the low friction road surface such as the soft road surface, the oversnow road surface and the like, the driving force of the tire is restricted, and it is possible to prevent the slip. Further, as shown in FIG. 7, in the case of working (excavating) by the working machine 27, a driving force of a vector A (a pressing force of the bucket 27a of the working machine 27 in the horizontal direction), and a working machine force of a vector B (an ascending force of the bucket 27a of the working machine 27 in the vertical direction) are applied to the working machine 27. Accordingly, it is possible to generate a resultant force C of the driving force and the working machine force, and the resultant force can be changed to C by changing the driving force so as to change the vector to A′. Accordingly, it is possible to change a direction and a magnitude of the resultant force (an excavating balance), and it is possible to make the working machine 27 to operate in correspondence to the subject to be excavated, whereby it is possible to carry out a reliable work. Further, since the maximum tilt angle is adjusted in accordance with an electronic control, it is possible to securely, continuously and delicately adjust the maximum traction force.

Further, it is possible to change the minimum tilt angle. In the case of changing (adjusting) the minimum tilt angle, it is possible to control (adjust) the motor minimum displacement, and it is possible to adjust the maximum speed between Z1 (minimum) and Z2 (maximum), as shown in FIG. 6. As mentioned above, when controlling the minimum displacement of the hydraulic motor 2 so as to control the maximum speed of the vehicle, it is possible, for example, to obtain a vehicle speed in correspondence to the working condition. In the case of having the working machine 27 (refer to FIG. 7) or the like, when ascending the working machine 27 at a high speed, the vehicle speed is set to a low speed, and it is possible to correspond to the work in the narrow space. Further, since the minimum tilt angle is adjusted in accordance with the electronic control using the solenoid type motor as mentioned above, it is possible to securely, continuously and delicately adjust the maximum speed. Further, since the adjustment is not carried out on the basis of the hydraulic control method, it is possible to achieve a simple circuit structure, and it is possible to achieve a reduction in cost.

Further, it is preferable that this vehicle is provided with a selecting means which can select whether or not the change of the hydraulic motor 2 is carried out. In other words, the selecting means carries out a selection whether or not the control for changing the maximum tilt angle is executed, and a selection whether or not the control for changing the minimum tilt angle is executed. Accordingly, in the case that the operator (the driver) wishes to change the maximum tilt angle of the hydraulic motor 2 or the minimum tilt angle thereof, it is possible to make the operator to carry out such a changing operation, and in the case that it is judged that such a changing operation is not required, it is possible to make the operator not to carry out such a changing operation, whereby it is possible to carry out the operation in which the vehicle speed is increased at the same time of carrying out the normal operation, that is, ascending the working machine at the maximum ascending speed. In this case, the selecting means maybe, for example, constituted by a structure which can select by connecting the changeover switch to the controller 23 mentioned above and operating the changeover switch. Accordingly, it is possible to carry out the operation (the work) in correspondence to a preference of the operator, the working condition or the like, and it is possible to achieve an improvement in a working efficiency.

The description is given above of the particular embodiment of the hydraulically driven vehicle in accordance with the present invention. However, the present invention is not limited to the embodiment mentioned above, and can be carried out by variously modifying-within the scope of the invention. For example, the variable displacement hydraulic motor 2 is not, limited to the bent axis type motor, and may be, of course, constituted by a swash plate type motor. Further, in the case of changing the maximum driving force of the hydraulic motor 2 the control can be simply and accurately executed on the basis of the electronic control as in the embodiment mentioned above. However, it is possible to change by using the hydraulic control method. Further, the vehicle is not limited to the wheel loader, and can be constituted by various construction machine provided with the working machine 27.

What is claimed is:

1. A hydraulically driven vehicle comprising a hydraulic motor (2) driven by a pressure oil discharged from a hydraulic pump (1) and supplied to the hydraulic motor (2) said hydraulically driven vehicle being traveled by driving the hydraulic motor (2), wherein a maximum driving force of the hydraulic motor (2) is set changeable.

2. A hydraulically driven vehicle as claimed in claim 1, wherein said hydraulic motor (2) is a variable displacement hydraulic motor, and a maximum tilt angle of the hydraulic motor (2) is set changeable.

3. A hydraulically driven vehicle as claimed in claim 2, wherein said maximum tilt angle is adjusted in accordance with an electronic control.

4. A hydraulically driven vehicle as claimed in claim 2, wherein a minimum tilt angle of said hydraulic motor (2) is adjusted in accordance with an electronic control.

5. A hydraulically driven vehicle as claimed in any one of claims 1 to 4, wherein the hydraulically driven vehicle is provided with a selecting means for selecting whether or not said change of said hydraulic motor (2) is executed.
